(19) United States
(12) Patent Application Publication
(10) Pub. No.: US 2008/0129493 A1
(43) Pub. Date: Jun. 5, 2008

(54) Shipping container monitoring system

(76) Inventors: Lazaro Fuentes, Easton, PA (US); Leopoldo M. Mayoral, Center Valley, PA (US)

Correspondence Address: FREDERIC M. DOUGLAS, 15333 CULVER DRIVE, SUITE 340 PMB 114, IRVINE, CA, 92604-3051, US

(21) Appl. No.: 11/541,597

(22) Filed: Dec. 1, 2006

(51) Int. Cl. G08B 1/08

(52) U.S. Cl. 340/539.22

(57) ABSTRACT

The present invention provides a method and apparatus for using a sensor array that detects environmental changes in or around a shipping container. Sensors detect NBC materials and detect tampering with the container (such as broken seals and open doors). The sensors are monitored remotely. The sensors are tracked for determining risk levels and communicating the risks to receiving ports, customs officials, shipping companies, and other interested entities. The sensors can also detect environmental conditions that may be important to the protection of cargo that may not be security-sensitive, but may require special conditions (such as perishable food). The system may categorize cargo into various levels of risk (such as mandatory inspection, occasional inspection, and random inspection).

### BACKGROUND OF THE INVENTION

The present invention relates generally to a method, apparatus, and system for remotely monitoring a shipping container, and, more particularly, to track cargo status, detect changes in cargo conditions, sense cargo environment, and to assess and control potential safety threats present in cargo.

Cargo transit (such as air, ocean, or land transportation) transports containers, vessels, and people. Certain containers, vessels, and/or people may pose safety and security threats. For example, a container may be diverted from a planned route, during which cargo may be exchanged for harmful substances, such as weapons of mass destruction (WMD). In another example, a criminal or fugitive may be hidden inside a container to avoid detection by a authorities. Such safety and security threats should be minimized. One way to minimize potential threats is by restricting containers that have a high probability of threat to areas outside an intended target, protected area, or sensitive environment.

The relevant public safety authorities prefer to receive information regarding cargo before the cargo reaches its intended destination. Any necessary exclusion of harmful materials or people should take place before the cargo reaches an intended target.

Currently, global positioning system (GPS) location logging is used to track shipping containers. The GPS system may be used to determine when a shipping container deviates from a planned route towards a destination. However, the current GPS systems do not provide the ability to categorize or prioritize potential security or safety threats posed by shipping containers that pose an elevated risk (such as wherein a seal has been broken in transit or wherein the shipping container performs a suspicious deviation from the planned route.

Thus, there is a need for a method, system, and apparatus for tracking a shipping container's status, environment (internal and external), and integrity while minimizing safety and security risks.

### SUMMARY OF THE INVENTION

In one aspect of the present invention, a shipping container, comprises a body having a door; a global positioning system unit; and a sensor array mounted within the shipping container and being operative to wirelessly transmit environmental condition information to a remote monitoring center regarding the environment of the shipping container; wherein the sensor array includes a nuclear sensor, a biological sensor, a chemical sensor, and a temperature sensor.

In another aspect of the present invention, a method, of transporting cargo in a shipping container via a transportation vehicle to a destination, comprises loading the cargo in the shipping container, the container including a container condition detector for monitoring container conditions; sealing the shipping container electronically; loading the shipping container onto the transportation vehicle; transporting the cargo via the transportation vehicle; monitoring conditions of the shipping container during transit using the container condition detector, evaluating container security risk; taking corrective action if the container security risk is high; proceeding to the destination if the container security risk is not high; and electronically unsealing the shipping container.

In a further aspect of the present invention, a shipping container comprises an opening capable of being sealed and unsealed; a sensor array including a route deviation detector situated within the container, the route deviation detector adapted to detect deviations from a planned route of the shipping container; and a link situated within the container and in communication with the route deviation detector, the link adapted to receive route deviation information from the route deviation detector and to transmit the route deviation information from the container to a remote monitoring center.

In a still further aspect of the present invention, an integrated, redundant, and orthogonal sensor array system for characterizing the nuclear, chemical, biological, atmospheric, and spectral internal environment of a maritime, air, or land cargo container wherein each phenomenology sensor generates a measurable signal and whose orthogonality to all other sensors increases the probability of detection and identification and minimizes the false alarm rate by correlating the sensor data, by analyzing the attributes of the environment at the time instant of collection, and by analyzing the time series stochastic trends of the data.

These and other aspects, objects, features and advantages of the present invention, are specifically set forth in, or will become apparent from, the following detailed description of an exemplary embodiment of the invention when read in conjunction with the accompanying drawings.

### BRIEF DESCRIPTION OF THE DRAWINGS

FIG. 1 is a plan view of a shipping container monitoring system, according to an embodiment of the present invention;

FIG. 2 is a perspective view of a shipping container, according to another embodiment of the present invention; and

FIG. 3 is a schematic of a sensor array, according to yet another embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

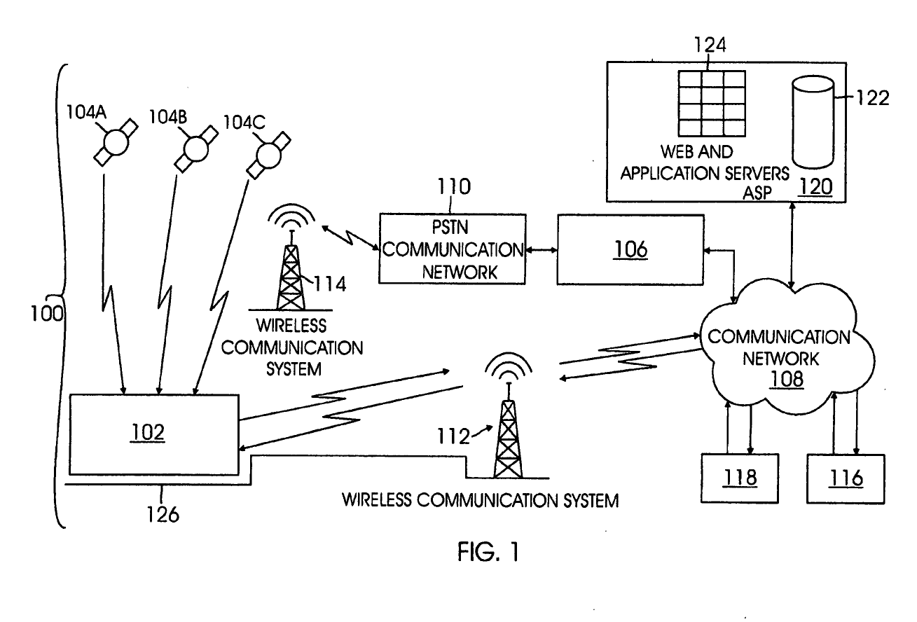

Referring now to the drawings, wherein like reference numerals designate identical or corresponding parts throughout several views, which are not necessarily drawn to scale, and more particularly referring to FIG. 1, the present invention provides a system 100 for transporting cargo in a shipping container 102 via a transportation vehicle 126 (such as a ship or a truck) to a destination 116. It should be understood that the present invention may be practiced such that shipping container 102 may take various forms, such as a cargo hold (for example, in aircraft, space craft, missiles, submarines, or any other type of storage space in any means of transportation).

Global positioning system (GPS) satellites 104A, 104B, 104C may provide location data (such as a longitudinal, latitudinal, and elevational position, an address, a nearby landmark, and the like) to a remote monitoring center 106. GPS satellites 104A, 104B, 104C are maintained and operated by the United States Department of Defense. The time it takes a global positioning system signal from a GPS satellite, such as 104A, to reach the shipping container 102 is used to calculate the distance from the GPS satellite 104A to the shipping container 102. Using measurements from multiple GPS satellites 104 (for example, three GPS satellites 104A, 104B, 104C), the system 100 may triangulate a location for the shipping container 102, providing a latitude and a longitude by comparing the measurements from the multiple GPS satellites 14 to the tracking device 20 and measurements of the distances between two or more GPS satellites 104A, 104B, 104C, and measurements of the relative orientations of the GPS satellites 104A, 104B, 104C, the shipping container 102, and the earth.

Continuing with FIG. 1, the system 100 may comprise a first wireless communication system 112 for communicating between the shipping container 102 and remote monitoring center 106. The first wireless communication system 112 may be connected (such as connected via a wireless link) to a communication network 108 and a public switched telephone network (PSTN) 110. An identification code of the shipping container 102 may be sent within a signal to the first wireless communication system 112.

A second wireless communication system 114 may be used within the system 100 for locating and tracking the shipping container 102. The second wireless communication system 114 may be used for communicating between the shipping container 102 and the remote monitoring center 106.

The remote monitoring center 106 may be linked to the communication network 108, which may be in communication with an application service provider (ASP) 120. The ASP 120 may include a database 122 and web and application servers 124.

The communication network 108 may be used to communicate necessary information, including warnings, to the destination 116 or to communicate with another shipping container 118.

General packet radio service (GPRS) signals may be used to locate and track the shipping container 102. GPRS is a non-voice service that allows information to be sent and received across a mobile telephone network. GPRS may supplement Circuit Switched Data (CSD) and Short Message Service (SMS). Although the acronym GPRS is similar to the acronym GPS, GPRS is not related to GPS. GPRS is an alternative service for locating and tracking individuals and objects.

A method for tracking the shipping container 102 may comprise loading the cargo in the shipping container 102, sealing the shipping container 102 electronically; loading the shipping container 102 onto the transportation vehicle 126; transporting the cargo via the transportation vehicle 126; monitoring conditions of the shipping container 102 during transit using the container condition detector; evaluating container security risk; taking corrective action if the container security risk is high; and proceeding to the destination 116 if the container security risk is not high. At the destination 116, the method may further comprise electronically unsealing the shipping container 102. The corrective action taken when the container security risk is high may comprise not proceeding to the destination 116.

In communication with the remote monitoring center 108 and other portions of the system 100 via the communication network 108, evaluating container security risk may comprise determining if there was a volumetric change in shipping container 102 contents (such as from an explosion or an implosion); determining if there was breach of a seal of the shipping container 102; determining if the shipping container 102 contents are radioactive; determining if there was a route deviation. These, and other container events may be logged.

The communication network 108 may be used for communicating a record of manifest information to the remote monitoring center 106, the manifest information including a description of the shipping container 102 contents; the destination 116; and a planned mute for the shipping container 102.

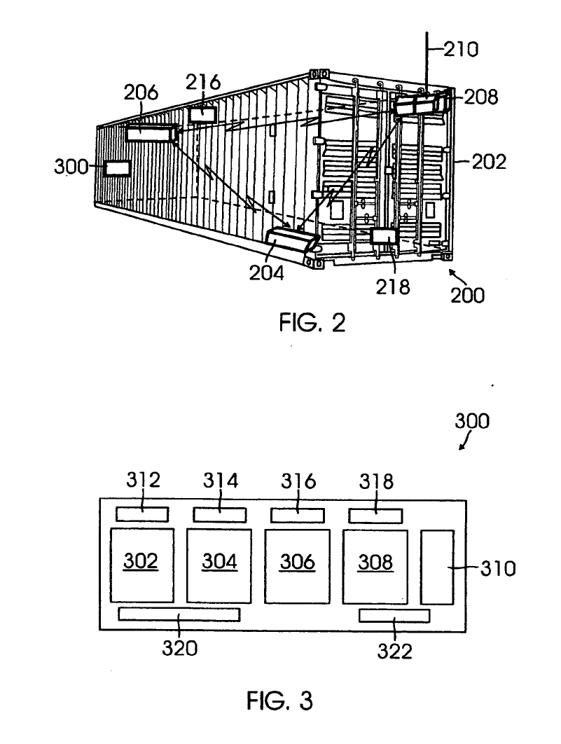

The database 122, or other storage media and/or locations, may be used for storing a date and time of significant events, including, location; door seal/unseal events; and shipping container 102 volumetric signatures. Door seal/unseal events may be detected via a radio frequency identification (RFID) tag; and/or a tamper detection unit (shown in FIG. 2 below). The method may also comprise detecting unauthorized opening of the shipping container 102 during transit of the shipping container 102. Additionally, the method may comprise unauthorized opening of the shipping container 102, other than opening of a shipping container 102 door during transit of the shipping container 102.

As shown in FIG. 2, a shipping container 200 may include a sensor array 204, 206 for monitoring container conditions. Door seal/unseal events may be detected via a radio frequency identification (RFID) tag 216; and/or a tamper detection unit 218. A sensor array (for example, sensor array 204) may be designated as the master controller and every other sensor array (for example, sensor array 206) within a container 200 may electronically report to the master sensor's interrogations as a slave. The shipping container 200 may comprise a body having a door 202; a global positioning system unit 208; and one or more sensor arrays 204, 206 mounted within the shipping container 200. The global positioning system unit 208 may be connected to a global positioning system antenna 210 for being operative to wirelessly transmit environmental condition information to a remote monitoring center 106 (shown in FIG. 1 above) regarding the environment of the shipping container 200. As a protection against spoofing or tampering, autonomous periodic transmission timings may be based on a pseudo-random code that is coherently coupled with the remote monitoring center 106 (shown in FIG. 1 above). The global positioning system antenna 210 may be used for receiving signals relating to location of the shipping container 200 and position reporting circuitry responsive (within the global positioning system unit 208) to an output from the global positioning system antenna 210 for providing environmental condition information to the remote monitoring center 106 (shown in FIG. 1 above). Similarly, an external connector, such as the antenna 210 may be used for communication from cargo to a command and control center, a cockpit, or other location for managing cargo status.

The internal environment may be of concern (such as whether harmful materials are contained in the shipping container 200 or if a person is inside the container) and the external environment of the shipping container 200 may be of concern (such as whether radioactivity is leaking from the shipping container 200 or in danger of leaking into a shipping container 200). Another concern may be whether out gassing occurs from cargo, such as, fruit, vegetable matter, textiles, or other materials that produce effluent, fugitive gasses, and the like. The sensor array 204, 206 may transmit environmental condition information regarding the internal environment in the shipping container 200 or the external environment of the shipping container 200. Some of the environmental condition information may include temperature, humidity, carbon dioxide concentration, light intrusion, barometric pressure, sound, an accurate time base, altitude, acceleration, and position, as well as other data. The sensor array 204, 206 may also provide health and status on the individual sensor arrays internal to the container 200 such as critical electrical sensors' array currents, battery life, data storage memory usage, component life, and system-invoked default operation modes such as a master unit defaulting to a slave unit. Accelerometers may be used, if the accelerometers are microelectromechanical machine system-based units whose outputs are used by a sensor array processor to compute container positions, detect impulse accelerations due to external stimuli, such as closing of doors, coupling of train knuckle couplers, drops and bumps.

The shipping container 200 may comprise an opening capable of being sealed and unsealed and a sensor array 300. The sensor array 300 is shown in FIG. 3. A route deviation detector 310 may be situated within the sensor array 300, the route deviation detector 310 being adapted to detect deviations from a planned route of the shipping container 200 (shown in FIG. 2 above). The sensor array 300 may also include a door open/close detection unit 312; a global positioning system-based route verification unit 314; an intrusion detection unit 316; a motion detection unit 318; a volumetric change detection unit 320; and a weapons of mass destruction detection unit 322. The weapons of mass destruction detection unit 322 may include a radioactivity sensing unit; a biological material sensing unit; and a chemical sensing unit. The sensor array 300 may include a nuclear sensor, a biological sensor, a chemical sensor, and/or a temperature sensor.

It should be understood, of course, that the foregoing relates to exemplary embodiments of the invention and that modifications may be made without departing from the spirit and scope of the invention as set forth in the following claims.

We claim:

1. A shipping container, comprising:
a body having a door;
a global positioning system unit; and
a sensor array mounted within the shipping container and being operative to wirelessly transmit environmental condition information to a remote monitoring center regarding the environment of the shipping container;
wherein the sensor array includes a nuclear sensor, a biological sensor, and a chemical sensor.

2. The shipping container of claim 1, wherein the sensor array transmits environmental condition information regarding the internal environment in the shipping container.

3. The shipping container of claim 1, wherein the sensor array transmits environmental condition information regarding the external environment of the shipping container.

4. The shipping container of claim 1, further comprising a global positioning system antenna for receiving signals relating to location of the shipping container and position reporting circuitry responsive to an output from the global positioning system antenna for providing environmental condition information to the remote monitoring center.

5. A method of transporting cargo in a shipping container via a transportation vehicle to a destination, comprising:
loading the cargo in the shipping container, the shipping container including a sensor array for monitoring container conditions;
sealing the shipping container electronically;
loading the shipping container onto the transportation vehicle;
transporting the cargo via the transportation vehicle;
monitoring conditions of the shipping container during transit using the container condition detector;
evaluating container security risk;
taking corrective action if the container security risk is high;
proceeding to the destination if the container security risk is not high;
and electronically unsealing the shipping container.

6. The method of claim 5, further comprising unsealing the shipping container electronically.

7. The method of claim 5, wherein the corrective action taken when the container security risk is high comprises not proceeding to the destination.

8. The method of claim 5, wherein evaluating container security risk comprises determining if there was a volumetric change in shipping container contents.

9. The method of claim 5, wherein evaluating container security risk comprises determining if there was breach of the seal of the shipping container.

10. The method of claim 5, wherein evaluating container security risk comprises determining if the container contents are radioactive.

11. The method of claim 5, wherein evaluating container security risk comprises determining if there was a route deviation.

12. The method of claim 5, further comprising logging container events.

13. The method of claim 5, further comprising communicating with another shipping container.

14. The method of claim 5, further comprising storing a date and time of significant events, including, location; door seal/unseal events; and shipping container volumetric signatures.

15. The method of claim 5, further comprising detecting unauthorized opening of the shipping container during transit of the container.

16. The method of claim 15, comprising detecting unauthorized opening of the shipping container, other than opening of a shipping container door during transit of the shipping container.

17. The method of claim 14, wherein door seal/unseal events are detected via a radio frequency identification (RFID) tag; and a tamper detection unit.

18. The method of claim 5, further comprising communicating a record of manifest information to a remote monitoring center, the manifest information including a description of the shipping container contents; the destination; and a planned route for the shipping container.

19. A shipping container, comprising:
a door open/close detection unit;
a global positioning system-based route verification unit;
an intrusion detection unit;
a motion detection unit;
a volumetric change detection unit; and
a weapons of mass destruction detection unit.

20. The shipping container of claim 19, wherein the weapons of mass destruction detection unit includes, a radioactivity sensing unit; a biological material sensing unit; and a chemical sensing unit.
